(19) United States
(12) Patent Application Publication
(10) Pub. No.: US 2010/0102931 A1
(43) Pub. Date: Apr. 29, 2010

(54) WIRELESS TRANSPONDER SYSTEM WITH POLARIZATION MODULATION

(75) Inventors: Pavel Nikitin, Seattle, WA (US); Venkata Kodukula, Bothell, WA (US); Rene Martinez, Seattle, WA (US)

Correspondence Address: SEED INTELLECTUAL PROPERTY LAW GROUP PLLC, 701 FIFTH AVENUE, SUITE 5400, SEATTLE, WA, 98104-7092, US

(73) Assignee: INTERMEC IP CORP., Everett, WA (US)

(21) Appl. No.: 12/257,575

(22) Filed: Oct. 24, 2008

(51) Int. Cl. H04Q 5/22

(52) U.S. Cl. 340/10.1

(57) ABSTRACT

A wireless transponder system includes at least one antenna configured to send transponder signals. The wireless transponder system also includes a wireless transponder circuit coupled to the at least one antenna, the wireless transponder circuit having a first state for sending transponder signals of a first polarization type and a second state for sending transponder signals of a second polarization type different than the first polarization type, and the wireless transponder circuit configured to encode information in a sequence of the transponder signals of the first polarization type alternating with the transponder signals of the second polarization type.

### BACKGROUND

1. Technical Field

This description generally relates to the field of wireless transponders, and more particularly to signal modulation used for wireless communication.

2. Description of the Related Art

Wireless communication devices, including wireless memory devices for storing and retrieving data, such as radio frequency identification (“RFID”) tags, are used in a variety of environments. Such devices typically employ an antenna coupled to a wireless transponder circuit to transmit and/or receive data via electromagnetic signals in some frequency range.

Active wireless memory devices further include a discrete consumable power source, such as a battery, to provide power to the wireless transponder circuit. In contrast, passive wireless memory devices derive power from a wireless interrogation signal, for example, by backscattering the interrogation signal as a response signal encoded with information from the wireless memory device.

The wireless transponder circuit found in many wireless memory devices includes a memory portion and a logic portion. The memory portion stores data, while the logic portion controls the reading, writing, and manipulating of data in the memory portion. The logic portion may further couple between the memory portion and the antenna to act as a transmitter, receiver, or transceiver for reading and/or writing data to and/or from the wireless memory device.

Typically, wireless communication devices employ linear or circularly polarized antennas and use amplitude or phase modulation for data reception and transmission. Unfortunately, wireless communications using such modulation techniques may have a limited range and may be subject to multi-path interference. It would therefore be desirable to have an improved wireless communications protocol.

### BRIEF SUMMARY

A wireless transponder system may be summarized as including: at least one antenna configured to send transponder signals; and a wireless transponder circuit coupled to the at least one antenna, the wireless transponder circuit having a first state for sending transponder signals of a first polarization type and a second state for sending transponder signals of a second polarization type different than the first polarization type, and the wireless transponder circuit configured to encode information in a sequence of the transponder signals of the first polarization type alternating with the transponder signals of the second polarization type.

The transponder signals of the first polarization type may comprise linearly polarized transponder signals having a first orientation, and the transponder signals of the second polarization type may comprise linearly polarized transponder signals having a second orientation different than the first orientation. Alternatively, the transponder signals of the first polarization type may comprise left hand elliptically polarized transponder signals (e.g., left hand circularly polarized transponder signals), and the transponder signals of the second polarization type may comprise right hand elliptically polarized transponder signals (e.g., right hand circularly polarized transponder signals).

The at least one antenna may comprise a first antenna configured to send the transponder signals of the first polarization type, and a second antenna configured to send the transponder signals of the second polarization type. The wireless transponder circuit may include a switch element configured to switch between the first antenna and the second antenna, and, in the first state, the switch element may be communicatively coupled to the first antenna, and, in the second state, the switch element may be communicatively coupled to the second antenna.

The at least one antenna may comprise a reconfigurable antenna having a first configuration for sending the transponder signals of the first polarization type and a second configuration for sending the transponder signals of the second polarization type. The first configuration of the reconfigurable antenna may be associated with the first state of the wireless transponder circuit, and the second configuration of the reconfigurable antenna may be associated with the second state of the wireless transponder circuit.

The wireless transponder system may further include: a wireless interrogator configured to transmit interrogation signals of the first polarization type and interrogation signals of the second polarization type in a frequency range in which the wireless transponder circuit operates. The wireless interrogator may include a first interrogator antenna configured to transmit the interrogation signals of the first polarization type and a second interrogator antenna configured to transmit the interrogation signals of the second polarization type, wherein the wireless interrogator is further configured to transmit the interrogation signals of the first polarization type and the interrogation signals of the second polarization type substantially simultaneously. The wireless transponder circuit may be further configured to collect power from the interrogation signals of the first polarization type and the interrogation signals of the second polarization type. The wireless transponder circuit may be further configured to collect power from the interrogation signals of the first polarization type in the first state, and to collect power from the interrogation signals of the second polarization type in the second state. The wireless transponder circuit may be further configured to backscatter the interrogation signals of the first polarization type and the interrogation signals of the second polarization type to encode the information. The wireless interrogator may be further configured to encode interrogation information in an interrogation sequence of the interrogation signals of the first polarization type alternating with the interrogation signals of the second polarization type. The wireless transponder circuit may be further configured to decode the interrogation information encoded by the wireless interrogator. The wireless interrogator may include a reconfigurable interrogator antenna having a first configuration for transmitting the interrogation signals of the first polarization type and a second configuration for transmitting the interrogation signals of the second polarization type. The wireless interrogator may be further configured to receive one of the transponder signals of the first polarization type or the transponder signals of the second polarization type sent by the wireless transponder circuit and to decode the information encoded in the sequence based at least in part on an interruption in the received transponder signals of the first polarization type or in the received transponder signals of the second polarization type.

The wireless transponder circuit may be a read/write passive radio frequency identification circuit having a memory, a read/write semi-passive radio frequency identification circuit having a memory, or a read/write active radio frequency identification circuit having a memory.

A wireless interrogator may be summarized as including: at least one interrogator antenna configured to transmit interrogation signals and to receive transponder signals; and a wireless interrogator circuit coupled to the at least one interrogator antenna, the wireless interrogator circuit configured to decode information encoded as a sequence of transponder signals of a first polarization type alternating with transponder signals of a second polarization type different than the first polarization type.

The transponder signals of the first polarization type may comprise linearly polarized transponder signals having a first orientation, and the transponder signals of the second polarization type may comprise linearly polarized transponder signals having a second orientation different than the first orientation. Alternatively, the transponder signals of the first polarization type may comprise left hand elliptically polarized transponder signals (e.g., left hand circularly polarized transponder signals), and the transponder signals of the second polarization type may comprise right hand elliptically polarized transponder signals (e.g., right hand circularly polarized transponder signals).

The at least one interrogator antenna may include a first interrogator antenna configured to transmit interrogation signals of the first polarization type and a second interrogator antenna configured to transmit interrogation signals of the second polarization type, wherein the wireless interrogator circuit is further configured to transmit the interrogation signals of the first polarization type and the interrogation signals of the second polarization type substantially simultaneously. The wireless interrogator circuit may be further configured to receive the transponder signals of the first polarization type of the sequence via the first interrogator antenna, and to receive the transponder signals of the second polarization type of the sequence via the second interrogator antenna.

The wireless interrogator circuit may be further configured to encode interrogation information in an interrogation sequence of interrogation signals of the first polarization type alternating with interrogation signals of the second polarization type.

The at least one interrogator antenna may include a reconfigurable interrogator antenna having a first configuration for transmitting interrogation signals of the first polarization type and a second configuration for transmitting interrogation signals of the second polarization type. The wireless interrogator circuit may be further configured to receive one of the transponder signals of the first polarization type or the transponder signals of the second polarization type and to decode the information encoded as the sequence based at least in part on an interruption in the received transponder signals of the first polarization type or in the received transponder signals of the second polarization type.

A method of wireless communication may be summarized as including: receiving interrogation signals at a wireless transponder; determining information for transmission from the wireless transponder; and sending the information from the wireless transponder encoded in a sequence of transponder signals of a first polarization type alternating with transponder signals of a second polarization type different than the first polarization type.

The transponder signals of the first polarization type may comprise linearly polarized transponder signals having a first orientation, and the transponder signals of the second polarization type may comprise linearly polarized transponder signals having a second orientation different than the first orientation. Alternatively, the transponder signals of the first polarization type may comprise left hand elliptically polarized transponder signals (e.g., left hand circularly polarized transponder signals), and the transponder signals of the second polarization type may comprise right hand elliptically polarized transponder signals (e.g., right hand circularly polarized transponder signals).

Sending the information may further include switching between a first antenna configured to send the transponder signals of the first polarization type and a second antenna configured to send the transponder signals of the second polarization type. Sending the information may also include reconfiguring a reconfigurable antenna between a first configuration for sending the transponder signals of the first polarization type and a second configuration for sending the transponder signals of the second polarization type. Sending the information may further include backscattering the interrogation signals.

Receiving the interrogation signals may comprise receiving interrogation signals of the first polarization type while sending the transponder signals of the first polarization type and receiving interrogation signals of the second polarization type while sending the transponder signals of the second polarization type. Receiving the interrogation signals may also include collecting power from the interrogation signals.

A method of wireless communication may be summarized as including: transmitting interrogation signals from a wireless interrogator; receiving a sequence of transponder signals of different polarization types at the wireless interrogator; and decoding information encoded in the sequence of transponder signals of different polarization types.

The sequence of transponder signals of different polarization types may comprise linearly polarized transponder signals having a first orientation alternating with linearly polarized transponder signals having a second orientation different than the first orientation. Alternatively, the sequence of transponder signals of different polarization types may comprise left hand elliptically polarized transponder signals (e.g., left hand circularly polarized transponder signals) alternating with right hand elliptically polarized transponder signals (e.g., right hand circularly polarized transponder signals).

Transmitting the interrogation signals may further include transmitting interrogation signals of a first polarization type and interrogation signals of a second polarization type different than the first polarization type substantially simultaneously. Transmitting the interrogation signals may further include transmitting interrogation information in an interrogation sequence of interrogation signals of a first polarization type alternating with interrogation signals of a second polarization type different than the first polarization type.

Receiving the sequence of transponder signals of different polarization types may include receiving transponder signals of a first polarization type and transponder signals of a second polarization type different than the first polarization type via separate interrogator antennas. Receiving the sequence of transponder signals of different polarization types may further include receiving one of transponder signals of a first polarization type or transponder signals of a second polarization type different than the first polarization type, and decoding the information encoded in the sequence includes interpolating the sequence based at least in part on an interruption in the received transponder signals of the first polarization type or in the received transponder signals of the second polarization type.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic view of a wireless transponder system, including a wireless transponder having two antennas and a wireless interrogator having two antennas, according to one illustrated embodiment.

FIG. 2 is a schematic view of another wireless transponder system including a wireless transponder having two antennas and a wireless interrogator having two antennas, according to one illustrated embodiment.

FIG. 3 is a schematic view of yet another wireless transponder system including a wireless transponder having a reconfigurable antenna and a wireless interrogator having a reconfigurable antenna, according to one illustrated embodiment.

FIG. 4 is a schematic view of a reconfigurable antenna for use with the wireless transponder or the wireless interrogator of FIG. 3, according to one illustrated embodiment.

FIG. 5 is a flow diagram illustrating a method of wireless communication, according to one illustrated embodiment.

FIG. 6 is a flow diagram illustrating another method of wireless communication, according to one illustrated embodiment.

### DETAILED DESCRIPTION OF EMBODIMENTS OF THE INVENTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with integrated circuits, antennas, radio frequency transmitters, receivers and transceivers, and encoding algorithms have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the embodiments.

### Description of an Exemplary Wireless Transponder System

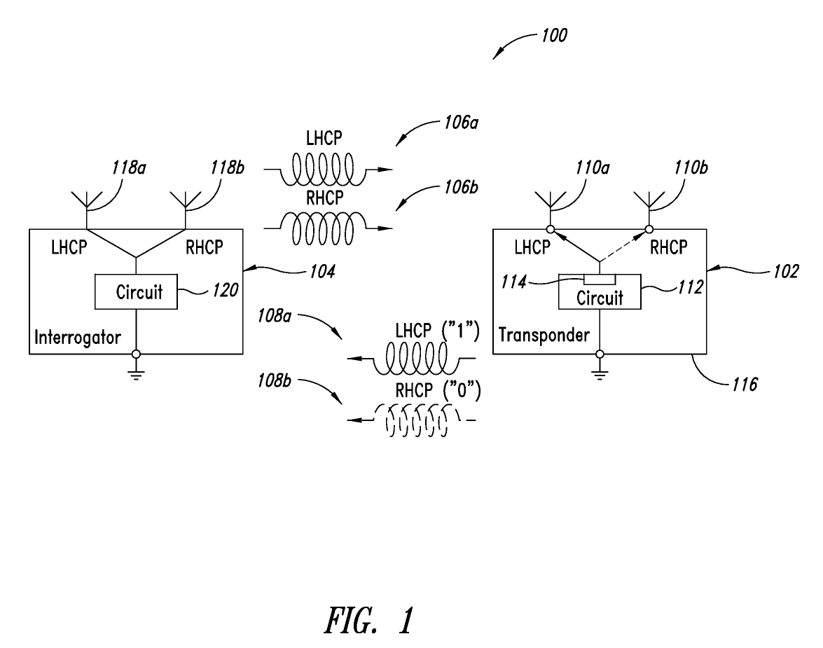

FIG. 1 shows a wireless transponder system 100, including a wireless transponder 102 and a wireless interrogator 104. As illustrated, the wireless transponder 102 and the wireless interrogator 104 may be configured to communicate with each other via electromagnetic signals having different polarization types. For example, the wireless interrogator 104 may transmit interrogation signals of a first polarization type 106a and interrogation signals of a second polarization type different than the first polarization type 106b to the wireless transponder 102. The wireless transponder 102 may, in turn, respond with transponder signals of the first polarization type 108a and transponder signals of the second polarization type 108b. In one embodiment, the wireless transponder 102 and the wireless interrogator 104 may be further configured to exchange information by modulating the polarization of the transmitted signals, such that a change in the polarization type of the signals encodes information.

The interrogation signals 106 and the transponder signals 108 may comprise signals having any of a variety of polarization types. In one embodiment, as illustrated, the interrogation signals of the first polarization type 106a may comprise left hand circularly polarized (“LHCP”) interrogation signals, and the interrogation signals of the second polarization type 106b may comprise right hand circularly polarized (“RHCP”) interrogation signals. Similarly, the transponder signals of the first polarization type 108a may comprise LHCP transponder signals, and the transponder signals of the second polarization type 108b may comprise RHCP transponder signals. Such polarization types are illustrated in FIGS. 1-4, and discussed in greater detail below. However, other polarization types may also be employed. For example, signals of the first polarization type may comprise left hand elliptically polarized (“LHEP”) signals, and signals of the second polarization type may comprise right hand elliptically polarized (“RHEP”) signals (LHCP and RHCP signals being just one example of such LHEP and RHEP signals). In other embodiments, signals of the first polarization type may comprise linearly or elliptically polarized signals having a first orientation (e.g., horizontal), and signals of the second polarization type may comprise linearly or elliptically polarized signals having a second orientation (e.g., vertical) different than the first orientation. Different hardware configurations may be employed to realize the different polarization types, as is discussed in greater detail below.

The wireless transponder 102 may comprise any of a variety of wireless communication devices for use in a variety of different environments. In one embodiment, the wireless transponder 102 may be affixed to a product and may store information indicative of the product. In another embodiment, the wireless transponder 102 may be configured to detect one or more environmental characteristics and to report such environmental characteristics to the wireless interrogator 104. In still another embodiment, the wireless transponder 102 may be associated with an identification document and may be queried using the wireless interrogator 104.

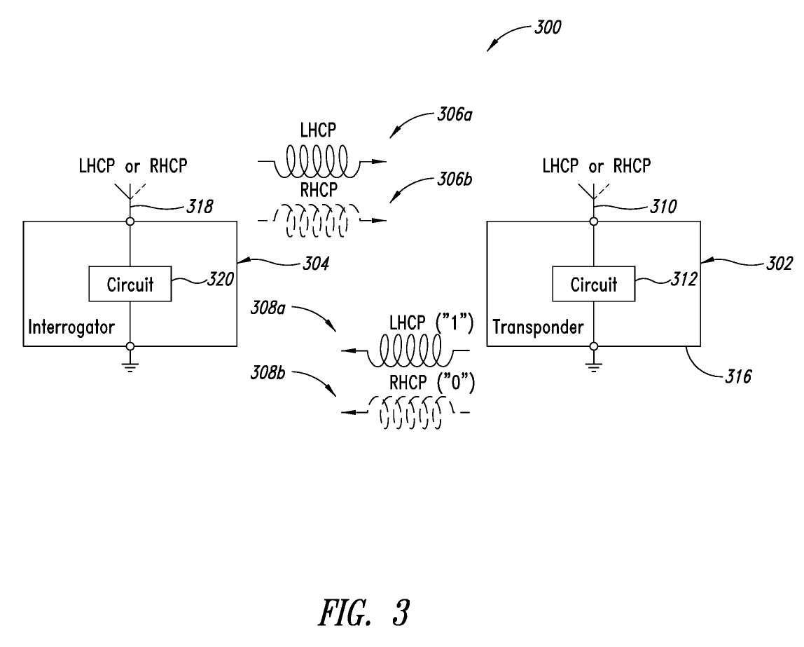

In one embodiment, the wireless transponder 102 may comprise at least one antenna 110a, 110b (collectively 110) configured to send the transponder signals 108a, 108b. As illustrated, the wireless transponder 102 includes a first antenna 110a configured to send the transponder signals of the first polarization type 108a (i.e., the LHCP transponder signals), and a second antenna 110b configured to send the transponder signals of the second polarization type 108b (i.e., the RHCP transponder signals). In other embodiments, the wireless transponder 102 may include more or fewer antennas for sending the transponder signals 108a, 108b. For example, as described in greater detail below with respect to FIG. 3, the wireless transponder may include a reconfigurable antenna having a first configuration for sending transponder signals of the first polarization type and a second configuration for sending transponder signals of the second polarization type.

The antennas 110 may have a variety of different shapes and configurations. In some embodiments, one or more dimensions of the antennas 110 may be relatively small in order to improve the portability of the wireless transponder 102. The shapes and sizes of the antennas 110 may also be selected to provide a desired communication range for the wireless transponder 102. In some embodiments, the antennas 110 may be configured similarly to one another, though configured for the opposite circular polarization. In other embodiments, the antennas 110 may be configured similarly with orthogonal polarization orientations. In still other embodiments, the antennas 110 may have very different configurations for achieving the corresponding polarization types.

The antennas 110 may also be coupled to the wireless transponder 102 in a variety of ways. The antennas 110 may be affixed to the wireless transponder 102 by welding, soldering, integrated manufacturing processes, etc.

The wireless transponder 102 may further comprise a wireless transponder circuit 112 coupled to the antennas 110. The wireless transponder circuit 112 may have a first state for sending the transponder signals of the first polarization type 108a and a second state for sending the transponder signals of the second polarization type 108b. In one embodiment, the wireless transponder circuit 112 is configured to encode information in a sequence of the transponder signals of the first polarization type 108a alternating with the transponder signals of the second polarization type 108b. Thus, polarization modulation may be employed to send information from the wireless transponder 102 to the wireless interrogator 104.

The wireless transponder circuit 112 may include a variety of circuitry for generating and receiving electromagnetic signals (e.g., elliptically polarized electromagnetic signals). In one embodiment, the wireless transponder circuit 112 is a radio frequency identification (“RFID”) circuit and may operate over a range of frequencies, such as 860-930 MHz, 2.45 GHz, or 5.8 GHz. An operating frequency of the wireless transponder circuit 112 may be selected based upon the circuitry as well as the antennas 110. In one embodiment, the operating frequency may be chosen to match an operating frequency of the wireless interrogator 104.

In one embodiment, the wireless transponder circuit 112 is a passive RFID circuit lacking a discrete power source, such as a battery. By relying upon remote powering, a passive RFID circuit may be made smaller than an “active” RFID circuit that includes a discrete power source and may have a longer operational life. In the passive embodiment, the wireless transponder circuit 112 may further include power circuitry for collecting power from an electromagnetic field, as described in greater detail below. In other embodiments, active RFID circuitry may be used, for example, to increase the range of the wireless transponder 102. In still other embodiments, semi-passive RFID circuitry may be used, in which a discrete power source is used for receiving electromagnetic signals from the wireless interrogator 104, but transponder signals 108 are sent by backscattering.

The wireless transponder circuit 112 may further comprise a read/write passive, semi-passive or active RFID circuit having a memory (not shown) for storing electronic data. The memory may be in the form of memory circuits, and the wireless transponder circuit 112 may further comprise logic circuits for storing, retrieving, and manipulating data in the memory. The wireless transponder circuit 112 may permit the logic circuits to receive and transmit data externally via electromagnetic signals.

In one embodiment, the wireless transponder circuit 112 may further include a switch element 114 configured to switch between the first antenna 110a and the second antenna 110b. Thus, in the first state of the wireless transponder circuit 112 (illustrated as a solid line in FIG. 1), the switch element 114 may be communicatively coupled to the first antenna 110a, and, in the second state of the wireless transponder circuit 112 (illustrated as a dashed line in FIG. 1), the switch element 114 may be communicatively coupled to the second antenna 110b. The switch element 114 may comprise any of a variety of electronic or electromechanical switches for selecting between the antennas 110. For example, in one embodiment, the switch element 114 may comprise a diode switch coupled to the antennas 110.

The wireless transponder circuit 112 may be configured to encode information in a sequence of transponder signals of the first polarization type 108a (e.g., LHCP transponder signals) alternating with transponder signals of the second polarization type 108b (e.g., RHCP transponder signals). In one embodiment, information may be encoded in a non-return-to-zero inverted (“NRZI”) code. That is, for every unit of time during a transmission, a polarization change may signify “1”, and no change may signify “0”. In another embodiment, as illustrated, information may be encoded using a non-return-to-zero (“NRZ”) code. That is, for every unit of time during a transmission, an LHCP transponder signal 108a may signify “1”, and an RHCP transponder signal 108b may signify “0”, or vice versa. Of course, other schemes for encoding information in the sequence of transponder signals 108 may also be used. For example, FM0, FM1, Miller or other encoding schemes may be used in some embodiments. The encoding scheme may also be selected such that it is compatible with the Class 1 Generation 2 UHF Air Interface Protocol Standard (“Gen 2”) promulgated by EPCglobal, Inc. In some embodiments, the encoding schemes may also incorporate error recovery/correction codes and/or other mechanisms for facilitating reliable data transfer.

The wireless transponder 102 may further include a housing 116 surrounding its internal circuitry, as illustrated. The housing 116 may protect the internal circuitry of the wireless transponder 102 from environmental effects; although, in other embodiments, the housing 116 may be omitted.

The wireless transponder system 100 may further include a wireless interrogator 104, which may exchange wireless signals with the wireless transponder 102. In one embodiment, the wireless interrogator 104 may be configured to receive at least one of the transponder signals of the first polarization type 108a or the transponder signals of the second polarization type 108b sent by the wireless transponder circuit 112 and may be configured to decode the information encoded in the sequence of transponder signals 108 generated by the wireless transponder circuit 112.

The wireless interrogator 104 may comprise any of a variety of wireless communication devices configured for communication with the wireless transponder 102. In one embodiment, the wireless interrogator 104 may comprise a handheld interrogator configured to transmit interrogation signals 106 in order to communicate with one or more wireless transponders 102. In other embodiments, other configurations for the wireless interrogator 104 may be employed.

The wireless interrogator 104 may be configured to transmit interrogation signals of the first polarization type 106a (e.g., LHCP interrogation signals) and interrogation signals of the second polarization type 106b (e.g., RHCP interrogation signals) in an operating frequency range of the wireless transponder circuit 112. In some embodiments, the interrogation signals 106 transmitted by the wireless interrogator 104 and the transponder signals 108 sent by the wireless transponder 102 may be at the same or a similar frequency. In other embodiments, the interrogation signals 106 may be transmitted at a different frequency than the transponder signals 108.

The wireless interrogator 104 may include at least one interrogator antenna 118a, 118b (collectively 118) configured to transmit the interrogation signals 106 and to receive the transponder signals 108. In other embodiments, a first set of antennas may be used for transmission of the interrogation signals 106, and a second set of antennas may be used for reception of the transponder signals 108. As illustrated, the wireless interrogator 104 may include a first interrogator antenna 118a configured to transmit the interrogation signals of the first polarization type 106a (e.g., LHCP interrogation signals) and a second interrogator antenna 118b configured to transmit the interrogation signals of the second polarization type 106b (e.g., RHCP interrogation signals). In other embodiments, the wireless interrogator 104 may include more or fewer antennas for transmitting the interrogation signals 106. For example, as described in greater detail below with respect to FIG. 3, the wireless interrogator may include a reconfigurable antenna having a first configuration for transmitting interrogation signals of the first polarization type and a second configuration for transmitting interrogation signals of the second polarization type.

The antennas 118 may have a variety of different shapes and configurations. In one embodiment, they may be configured to provide a desired communication range for the wireless interrogator 104. In some embodiments, the antennas 118 may be configured similarly to one another, though configured for the opposite circular polarization; however, in other embodiments, the antennas 118 may have very different configurations for achieving the corresponding polarization types.

The wireless interrogator 104 may further include a wireless interrogator circuit 120 coupled to the interrogator antennas 118. In one embodiment, the wireless interrogator circuit 120 may be configured to decode the information from the wireless transponder 102 encoded in the sequence of transponder signals of the first polarization type 108a alternating with transponder signals of the second polarization type 108b. In some embodiments, the wireless interrogator circuit 120 may be further configured to encode interrogation information in an interrogation sequence of the interrogation signals of the first polarization type 106a alternating with the interrogation signals of the second polarization type 106b. In such embodiments, the wireless transponder 102 may, in turn, be configured to decode this interrogation information.

In one embodiment, as illustrated, the wireless interrogator circuit 120 may be simultaneously communicatively coupled to the two interrogator antennas 118a, 118b. In such an embodiment, the wireless interrogator circuit 120 may be configured to receive the transponder signals of the first polarization type 108a of the sequence via the first interrogator antenna 118a, and the transponder signals of the second polarization type 108b of the sequence via the second interrogator antenna 118b. The wireless interrogator circuit 120 may then decode the sequence sent by the wireless transponder 102 based on both the transponder signals 108. In other embodiments, the wireless interrogator circuit 120 may be configured to receive only one of the transponder signals of the first polarization type 108a or the transponder signals of the second polarization type 108b. For example, the wireless interrogator 104 may be configured to receive transponder signals 108 over just one of the antennas 118. In such an embodiment, the wireless interrogator 104 may receive a pattern of LHCP or RHCP transponder signals 108a, 108b, and then, based at least in part on an interruption in the received transponder signals 108, the wireless interrogator 104 may interpolate the original sequence and thus decode the transmitted information.

In some embodiments, the interrogation signals 106 transmitted by the wireless interrogator 104 may serve at least two purposes. First, the interrogation signals 106 may be configured to provide power to the wireless transponder 102 (e.g., when the wireless transponder circuit 112 comprises a passive or semi-passive RFID circuit). This purpose may be served during a “powering phase” of communication with the wireless transponder 102. Second, the interrogation signals 106 may be used to transmit interrogation information to the wireless transponder 102 encoded as an interrogation sequence. This purpose may be achieved during an “interrogation phase” of communication with the wireless transponder 102. Of course, it may be understood that these two phases may overlap. For example, the wireless transponder 102 may derive power from the interrogation signals 106 even as the signals 106 are sent in a specific interrogation sequence.

In one embodiment, when providing power to the wireless transponder 102, the wireless interrogator circuit 120 may be configured to transmit both the interrogation signals of the first polarization type 106a and the interrogation signals of the second polarization type 106b substantially simultaneously using the corresponding interrogator antennas 118a, 118b. The interrogation signals 106 may be transmitted substantially constantly during this powering phase. In such an embodiment, the wireless transponder circuit 112 may be configured to collect power from the interrogation signals of the first polarization type 106a and the interrogation signals of the second polarization type 106b originating from the wireless interrogator 104. For example, the wireless transponder circuit 112 may be configured to collect power from and backscatter the LHCP interrogation signals 106a in the first state and to collect power from and backscatter the RHCP interrogation signals 106b in the second state. Thus, regardless of the active antenna 110a, 110b, the wireless transponder 102 may substantially continuously receive electromagnetic energy from the wireless interrogator 104.

In other embodiments, the wireless interrogator circuit 120 may be configured to transmit only interrogation signals of the first polarization type 106a or interrogation signals of the second polarization type 106b during a powering phase, and the wireless transponder 102 may only collect power from one of these interrogation signals 106. In still other embodiments, the wireless transponder circuit 112 may comprise an active RFID circuit and may not collect power from the interrogation signals 106.

The interrogation signals 106 may also be used to encode interrogation information. As described above, any of a variety of encoding schemes may be used. For example, NRZ, NRZI, FM0, FM1, Miller or other encoding schemes may be used. In one embodiment, the interrogation information may be encoded using the same encoding scheme as that used for the information sent by the wireless transponder 102. However, in other embodiments, different encoding schemes may be used.

In one embodiment, the use of the elliptically polarized interrogation signals 106 and transponder signals 108 may mitigate the effects of multi-path interference because reflected signals switch their elliptical polarization.

Description of another Exemplary Wireless Transponder System

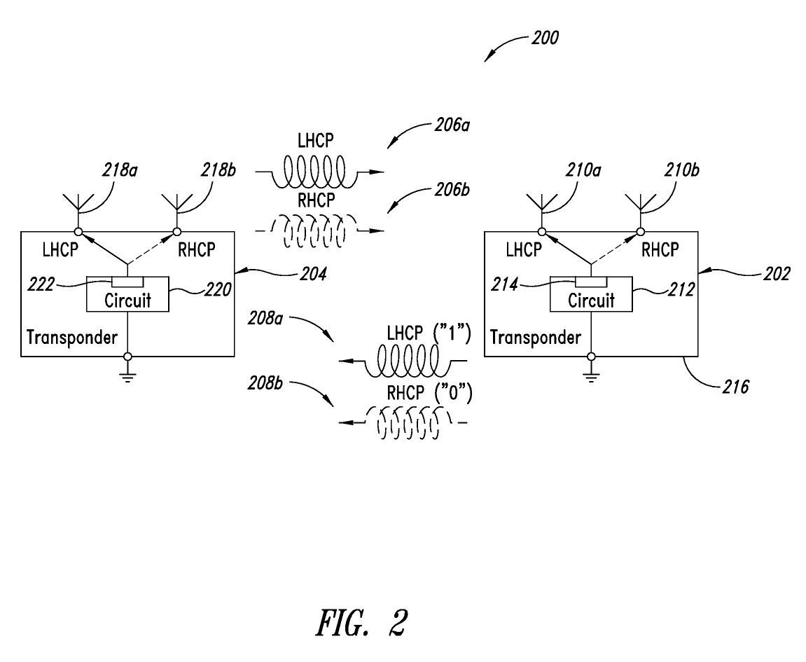

FIG. 2 shows another wireless transponder system 200, including a wireless transponder 202 and a wireless interrogator 204. As illustrated, the wireless transponder 202 may be configured identically to the wireless transponder 102, with like numerals referring to like parts. The wireless interrogator 204 may be configured similarly to the wireless interrogator 104, with like numerals referring to like parts. However, there are differences between these wireless interrogators 104, 204, as described in greater detail below.

The wireless interrogator 204 may include first and second interrogator antennas 218a, 218b configured to transmit respective interrogation signals 206a, 206b and to receive respective transponder signals 208a, 208b. The wireless interrogator 204 may also include a wireless interrogator circuit 220 coupled to the interrogator antennas 218a, 218b. However, unlike the embodiment illustrated in FIG. 1, the wireless interrogator 204 may further include an interrogator switch element 222 for switching between the interrogator antennas 218a, 218b.

In one embodiment, the wireless interrogator circuit 220 may be configured to transmit only one or the other of the interrogation signals of the first polarization type 206a (e.g., LHCP interrogation signals) and the interrogation signals of the second polarization type 206b (e.g., RHCP interrogation signals) at a time. Although this may not impact the operation of the wireless interrogator 204 during an interrogation phase, the wireless interrogator 204 may be configured to transmit only the interrogation signals of the first polarization type 206a or the interrogation signals of the second polarization type 206b during a powering phase, and the wireless transponder 202 may thus be configured to only collect power from one of these interrogation signals 206.

Description of yet another Exemplary Wireless Transponder System

FIG. 3 shows another wireless transponder system 300, including a wireless transponder 302 and a wireless interrogator 304. As illustrated, the wireless transponder 302 may be configured similarly to the wireless transponder 102, with like numerals referring to like parts. The wireless interrogator 304 may also be configured similarly to the wireless interrogator 104, with like numerals referring to like parts. The differences between the wireless transponder system 300 and the wireless transponder system 100 are described in greater detail below.

In one embodiment, the wireless transponder 302 may include a reconfigurable antenna 310. As illustrated schematically, the reconfigurable antenna 310 of the wireless transponder 302 may have a first configuration for sending transponder signals of a first polarization type 308a and a second configuration for sending transponder signals of a second polarization type 308b. The wireless transponder circuit 312 may control the configuration of the reconfigurable antenna 310, or other external or internal circuitry may control the configuration. Thus, in terms of the first and second states described above with reference to the wireless transponder circuit 112, the first configuration of the reconfigurable antenna 310 may be associated with the first state of the wireless transponder circuit 312, and the second configuration of the reconfigurable antenna 310 may be associated with the second state of the wireless transponder circuit 312.

In one embodiment, the wireless interrogator 304 may also include a reconfigurable interrogator antenna 318. As illustrated, the reconfigurable interrogator antenna 318 may have a first configuration for transmitting interrogation signals of the first polarization type 306a and a second configuration for transmitting interrogation signals of the second polarization type 306b. The wireless interrogator circuit 320 may control the configuration of the reconfigurable interrogator antenna 318, or other external or internal circuitry may control the configuration.

Although the wireless transponder system 300 is illustrated with reconfigurable antennas at both the wireless transponder 302 and the wireless interrogator 304, in other embodiments, the wireless transponder 302 and the wireless interrogator 304 may have different configurations for their respective antennas. For example, in one wireless transponder system, a wireless transponder may be configured similarly to the wireless transponder 102, and a wireless interrogator may be configured similarly to the wireless interrogator 304.

### Description of an Exemplary Reconfigurable Antenna

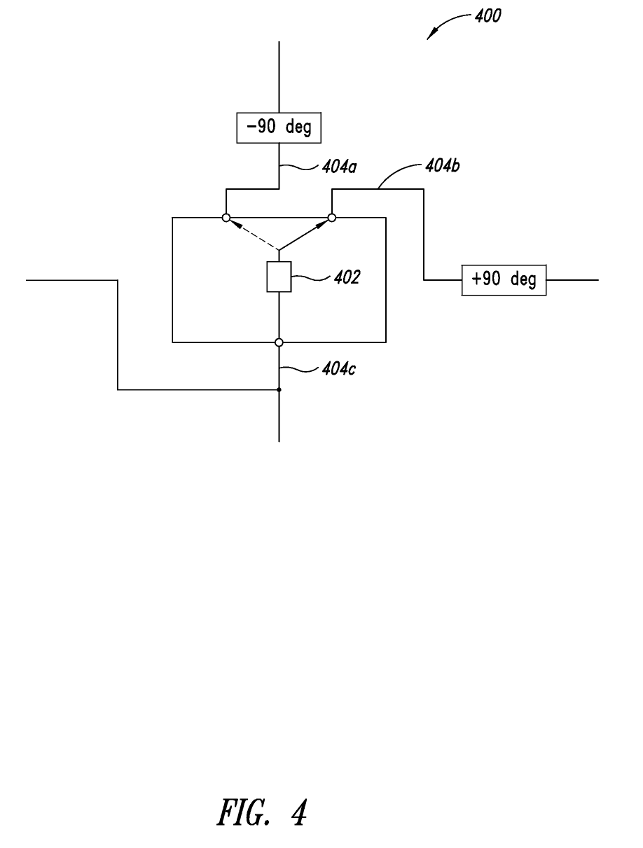

FIG. 4 shows a reconfigurable antenna 400 that may serve as either the reconfigurable antenna 310 or the reconfigurable interrogator antenna 318 illustrated in FIG. 3. The reconfigurable antenna 400 may include a switch element 402 configured to communicatively couple wireless circuitry (not shown) with a first antenna structure 404a or a second antenna structure 404b. The reconfigurable antenna 400 may further include a third antenna structure 404c that may remain communicatively coupled to the wireless circuitry regardless of the state of the switch element 402.

As illustrated, the first antenna structure 404a and the second antenna structure 404b may have different phase relationships with the third antenna structure 404c. For example, the first antenna structure 404a may be configured to propagate a signal shifted 90 degrees out of phase behind a signal from the third antenna structure 404c, and the second antenna structure 404b may be configured to propagate a signal shifted 90 degrees out of phase in front of a signal from the third antenna structure 404c. Of course, in other embodiments, other phase relationships may be used to generate circularly polarized signals at the reconfigurable antenna 400.

The reconfigurable antenna 400 may have a first configuration for transmitting LHCP electromagnetic signals and a second configuration for transmitting RHCP electromagnetic signals. As illustrated, if the reconfigurable antenna 400 is used to broadcast circularly polarized signals out from the page of FIG. 4 in a direction of the viewer, then the first antenna structure 404a may be employed to transmit LHCP signals, and the second antenna structure 404b may be employed to transmit RHCP signals.

In one embodiment, the reconfigurable antenna 400 may be relatively flat, thus improving the portability of a wireless transponder or wireless interrogator incorporating the antenna 400. Of course, in other embodiments, other reconfigurable antennas may be employed with varying geometries and circuit configurations.

### Description of an Exemplary Method for Wireless Communications

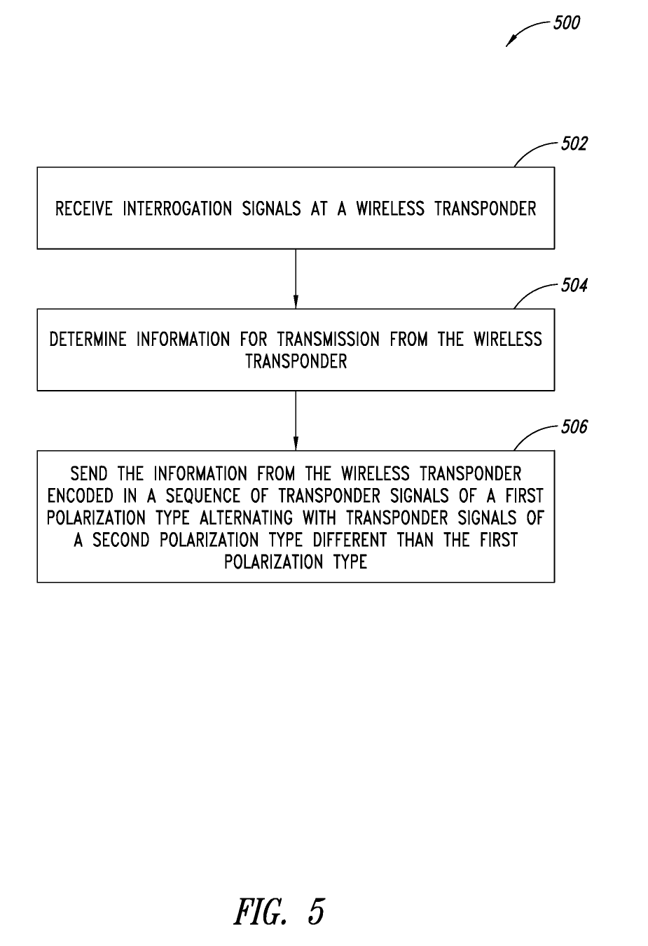

FIG. 5 illustrates a flow diagram for a method 500 of wireless communication, according to one embodiment. This method 500 will be discussed in the context of the wireless transponder system 100. However, it may be understood that the acts disclosed herein may also be executed using a variety of wireless transponder systems, including the wireless transponder systems 200, 300 discussed above, in accordance with the described method.

In addition, the acts of method 500 may be executed by the wireless transponder 102. However, in other embodiments, other wireless transponders or other wireless communication devices may execute one or more acts of the method 500.

The method begins at 502, when interrogation signals 106 are received at the wireless transponder 102. The interrogation signals 106 received at the wireless transponder 102 may comprise the interrogation signals of the first polarization type 106a, the interrogation signals of the second polarization type 106b, or both transmitted from the wireless interrogator 104.

In one embodiment, the wireless transponder 102 may only receive the interrogation signals 106 if the wireless transponder 102 is in the proper state to receive the interrogation signals 106. For example, as illustrated in FIG. 1, the wireless transponder 102 may receive the LHCP interrogation signals 106a in a first state when the switch element 114 is communicatively coupled to the first antenna 110a, and the wireless transponder 102 may receive the RHCP interrogation signals 106b in a second state when the switch element 114 is communicatively coupled to the second antenna 110b. In other embodiments, the wireless transponder 102 may receive both the LHCP interrogation signals 106a and the RHCP interrogation signals 106b substantially simultaneously using a dual antenna system configured similarly to the antennas 118 of the wireless interrogator 104.

In one embodiment, the interrogation signals 106 may simply comprise one or more substantially constant signals configured to power the wireless transponder 102 during a powering phase. In an interrogation phase, the interrogation signals 106 may comprise an interrogation sequence of signals of alternating polarization types that may be used to communicate interrogation information to the wireless transponder 102.

In one embodiment, the wireless transponder 102 may be configured to collect power from the interrogation signals 106. For example, the wireless transponder 102 may include one or more circuit elements configured to derive power from the interrogation signals 106.

At 504, information for transmission from the wireless transponder 102 is determined. This information may comprise any of a variety of information that may have been stored on the wireless transponder 102, or that may be determined by the wireless transponder 102. For example, the information may comprise information indicative of a product, information indicative of past or present environmental characteristics, information indicative of an identification document, etc.

In one embodiment, the information may be determined by the wireless transponder circuit 112 independently of the interrogation signals 106 received from the wireless interrogator 104. However, in other embodiments, the wireless transponder circuit 112 may determine the information for transmission based at least in part upon the interrogation signals 106. For example, the wireless transponder circuit 112 may decode interrogation information encoded in the interrogation signals 106 and may determine the information for transmission based at least in part upon this interrogation information.

At 506, the information is sent from the wireless transponder 102 encoded in a sequence of transponder signals of a first polarization type 108a alternating with transponder signals of a second polarization type 108b different than the first polarization type. As described above, the wireless transponder 102 may encode the information using any of a variety of encoding schemes.

In one embodiment, the wireless transponder 102 may send the information by switching between the first antenna 110a configured to send the transponder signals of the first polarization type 108a and the second antenna 110b configured to send the transponder signals of the second polarization type 108b, as illustrated in FIG. 1. In another embodiment, a wireless transponder 302 may send the information by reconfiguring a reconfigurable antenna 310 between a first configuration for sending transponder signals of the first polarization type 308a and a second configuration for sending transponder signals of the second polarization type 308b, as illustrated in FIG. 3.

As described above, the wireless transponder 102 may be configured to receive the interrogation signals 106 substantially concurrently with transmission of corresponding transponder signals 108. That is, in a first state, the wireless transponder 102 may be configured to receive the interrogation signals of the first polarization type 106a while sending the transponder signals of the first polarization type 108a. Then, in a second state, the wireless transponder 102 may be configured to receive the interrogation signals of the second polarization type 106b while sending the transponder signals of the second polarization type 108b.

Description of another Exemplary Method for Wireless Communications

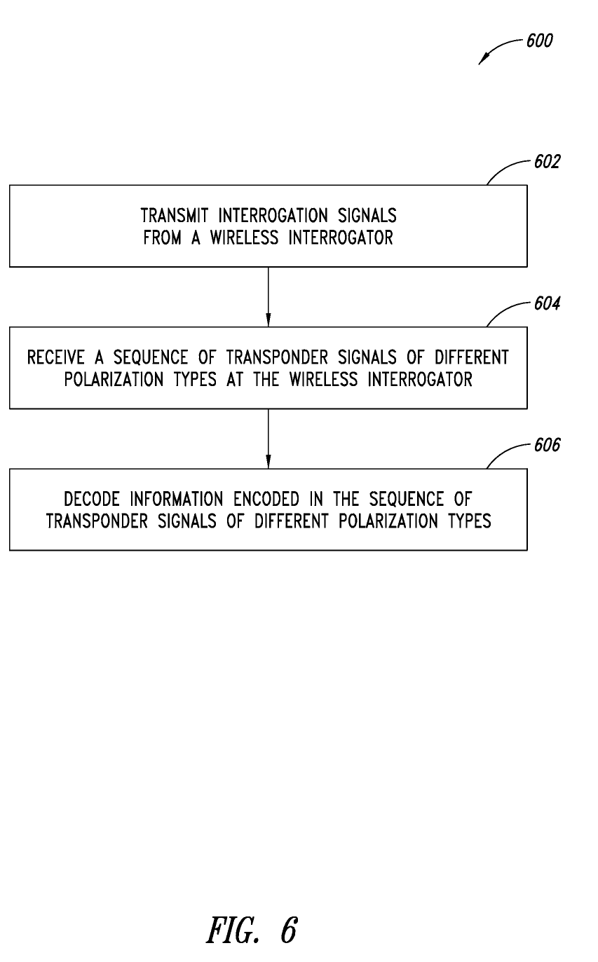

FIG. 6 illustrates a flow diagram for another method 600 of wireless communication, according to one embodiment. This method 600 will be discussed in the context of the wireless transponder system 100. However, it may be understood that the acts disclosed herein may also be executed using a variety of wireless transponder systems, including the wireless transponder systems 200, 300 discussed above, in accordance with the described method.

In addition, the acts of method 600 may be executed by the wireless interrogator 104. However, in other embodiments, other wireless interrogators or other wireless communication devices may execute one or more acts of the method 600.

The method begins at 602, when interrogation signals 106 are transmitted from a wireless interrogator 104. The interrogation signals 106 may comprise the interrogation signals of the first polarization type 106a, the interrogation signals of the second polarization type 106b, or both.

In one embodiment, the interrogation signals 106 may comprise one or more substantially constant signals configured to power the wireless transponder 102 during a powering phase. In an interrogation phase, the interrogation signals 106 may comprise an interrogation sequence of signals of alternating polarization types that may be used to communicate interrogation information to the wireless transponder 102.

In one embodiment, the wireless interrogator 104 may be configured to transmit both interrogation signals of the first polarization type 106a and interrogation signals of the second polarization type 106b substantially simultaneously. However, in other embodiments (as shown in FIGS. 2 and 3), the wireless interrogator may include a switch element 222 or a reconfigurable antenna 318 such that only one or the other of the interrogation signals may be transmitted at one time.

At 604, a sequence of transponder signals 108 of different polarization types is received at the wireless interrogator 104. As described above, the sequence may comprise any of a variety of sequences generated using a variety of encoding schemes.

In one embodiment, the wireless interrogator 104 may be configured to receive both the transponder signals of the first polarization type 108a and the transponder signals of the second polarization type 108b via separate interrogator antennas 118a, 118b, respectively. In such an embodiment, the wireless interrogator 104 may receive the entire sequence of transponder signals 108, and this entire sequence may be used in order to decode the information at 606. In other embodiments, the wireless interrogator 104 may be configured to receive one of the transponder signals of the first polarization type 108a or the transponder signals of the second polarization type 108b, and a remainder of the sequence of the transponder signals 108 may be determined based at least in part upon interruptions in the received signals.

At 606, information encoded in the sequence of transponder signals 108 of different polarization types is decoded. In one embodiment, the wireless interrogator 104 may receive the entire sequence of transponder signals 108 and may decode the information based on this sequence. However, in other embodiments, when the wireless interrogator 104 only receives one or the other of the transponder signals 108, decoding the information may include interpolating the sequence based at least in part on an interruption in the received transponder signals 108a, 108b.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more programs executed by one or more processors, as one or more programs executed by one or more controllers (e.g., microcontrollers), as firmware, or as virtually any combination thereof, and that designing the circuitry and/or writing the code for the software and or firmware would be well within the skill of one of ordinary skill in the art in light of this disclosure.

When logic is implemented as software and stored in memory, one skilled in the art will appreciate that logic or information can be stored on any computer readable storage medium for use by or in connection with any processor-related system or method. In the context of this document, a memory is a computer readable storage medium that is an electronic, magnetic, optical, or other physical device or means that contains or stores a computer and/or processor program and/or data or information. Logic and/or the information can be embodied in any computer readable storage medium for use by or in connection with an instruction execution system, apparatus, or device, such as a computer-based system, processor-containing system, or other system that can fetch the instructions from the instruction execution system, apparatus, or device and execute the instructions associated with logic and/or information.

The various embodiments described above can be combined to provide further embodiments. From the foregoing it will be appreciated that, although specific embodiments have been described herein for purposes of illustration, various modifications may be made without deviating from the spirit and scope of the teachings. Accordingly, the claims are not limited by the disclosed embodiments.

We/I claim:

1. A wireless transponder system, comprising:
at least one antenna configured to send transponder signals; and
a wireless transponder circuit coupled to the at least one antenna, the wireless transponder circuit having a first state for sending transponder signals of a first polarization type and a second state for sending transponder signals of a second polarization type different than the first polarization type, and the wireless transponder circuit configured to encode information in a sequence of the transponder signals of the first polarization type alternating with the transponder signals of the second polarization type.

2. The wireless transponder system of claim 1, wherein the transponder signals of the first polarization type comprise linearly polarized transponder signals having a first orientation, and the transponder signals of the second polarization type comprise linearly polarized transponder signals having a second orientation different than the first orientation.

3. The wireless transponder system of claim 1, wherein the transponder signals of the first polarization type comprise left hand elliptically polarized transponder signals, and the transponder signals of the second polarization type comprise right hand elliptically polarized transponder signals.

4. The wireless transponder system of claim 3, wherein the left hand elliptically polarized transponder signals comprise left hand circularly polarized transponder signals, and the right hand elliptically polarized transponder signals comprise right hand circularly polarized transponder signals.

5. The wireless transponder system of claim 1, wherein the at least one antenna comprises a first antenna configured to send the transponder signals of the first polarization type, and a second antenna configured to send the transponder signals of the second polarization type.

6. The wireless transponder system of claim 5, wherein the wireless transponder circuit includes a switch element configured to switch between the first antenna and the second antenna, and wherein, in the first state, the switch element is communicatively coupled to the first antenna, and, in the second state, the switch element is communicatively coupled to the second antenna.

7. The wireless transponder system of claim 1, wherein the at least one antenna comprises a reconfigurable antenna having a first configuration for sending the transponder signals of the first polarization type and a second configuration for sending the transponder signals of the second polarization type.

8. The wireless transponder system of claim 7, wherein the first configuration of the reconfigurable antenna is associated with the first state of the wireless transponder circuit and the second configuration of the reconfigurable antenna is associated with the second state of the wireless transponder circuit.

9. The wireless transponder system of claim 1, further comprising:
a wireless interrogator configured to transmit interrogation signals of the first polarization type and interrogation signals of the second polarization type in a frequency range in which the wireless transponder circuit operates.

10. The wireless transponder system of claim 9, wherein the wireless interrogator includes a first interrogator antenna configured to transmit the interrogation signals of the first polarization type and a second interrogator antenna configured to transmit the interrogation signals of the second polarization type, and wherein the wireless interrogator is further configured to transmit the interrogation signals of the first polarization type and the interrogation signals of the second polarization type substantially simultaneously.

11. The wireless transponder system of claim 10, wherein the wireless transponder circuit is further configured to collect power from the interrogation signals of the first polarization type and the interrogation signals of the second polarization type.

12. The wireless transponder system of claim 11, wherein the wireless transponder circuit is further configured to collect power from the interrogation signals of the first polarization type in the first state, and to collect power from the interrogation signals of the second polarization type in the second state.

13. The wireless transponder system of claim 9, wherein the wireless transponder circuit is further configured to backscatter the interrogation signals of the first polarization type and the interrogation signals of the second polarization type to encode the information.

14. The wireless transponder system of claim 9, wherein the wireless interrogator is further configured to encode interrogation information in an interrogation sequence of the interrogation signals of the first polarization type alternating with the interrogation signals of the second polarization type.

15. The wireless transponder system of claim 14, wherein the wireless transponder circuit is further configured to decode the interrogation information encoded by the wireless interrogator.

16. The wireless transponder system of claim 9, wherein the wireless interrogator includes a reconfigurable interrogator antenna having a first configuration for transmitting the interrogation signals of the first polarization type and a second configuration for transmitting the interrogation signals of the second polarization type.

17. The wireless transponder system of claim 9, wherein the wireless interrogator is further configured to receive one of the transponder signals of the first polarization type or the transponder signals of the second polarization type sent by the wireless transponder circuit and to decode the information encoded in the sequence based at least in part on an interruption in the received transponder signals of the first polarization type or in the received transponder signals of the second polarization type.

18. The wireless transponder system of claim 1, wherein the wireless transponder circuit is a read/write passive radio frequency identification circuit having a memory.

19. The wireless transponder system of claim 1, wherein the wireless transponder circuit is a read/write semi-passive radio frequency identification circuit having a memory.

20. The wireless transponder system of claim 1, wherein the wireless transponder circuit is a read/write active radio frequency identification circuit having a memory.

21. A wireless interrogator, comprising:
at least one interrogator antenna configured to transmit interrogation signals and to receive transponder signals; and
a wireless interrogator circuit coupled to the at least one interrogator antenna, the wireless interrogator circuit configured to decode information encoded as a sequence of transponder signals of a first polarization type alternating with transponder signals of a second polarization type different than the first polarization type.

22. The wireless interrogator of claim 21, wherein the transponder signals of the first polarization type comprise linearly polarized transponder signals having a first orientation, and the transponder signals of the second polarization type comprise linearly polarized transponder signals having a second orientation different than the first orientation.

23. The wireless interrogator of claim 21, wherein the transponder signals of the first polarization type comprise left hand elliptically polarized transponder signals, and the transponder signals of the second polarization type comprise right hand elliptically polarized transponder signals.

24. The wireless interrogator of claim 23, wherein the left hand elliptically polarized transponder signals comprise left hand circularly polarized transponder signals, and the right hand elliptically polarized transponder signals comprise right hand circularly polarized transponder signals.

25. The wireless interrogator of claim 21, wherein the at least one interrogator antenna includes a first interrogator antenna configured to transmit interrogation signals of the first polarization type and a second interrogator antenna configured to transmit interrogation signals of the second polarization type, and wherein the wireless interrogator circuit is further configured to transmit the interrogation signals of the first polarization type and the interrogation signals of the second polarization type substantially simultaneously.

26. The wireless interrogator of claim 25, wherein the wireless interrogator circuit is further configured to receive the transponder signals of the first polarization type of the sequence via the first interrogator antenna, and to receive the transponder signals of the second polarization type of the sequence via the second interrogator antenna.

27. The wireless interrogator of claim 21, wherein the wireless interrogator circuit is further configured to encode interrogation information in an interrogation sequence of interrogation signals of the first polarization type alternating with interrogation signals of the second polarization type.

28. The wireless interrogator of claim 21, wherein the at least one interrogator antenna includes a reconfigurable interrogator antenna having a first configuration for transmitting interrogation signals of the first polarization type and a second configuration for transmitting interrogation signals of the second polarization type.

29. The wireless interrogator of claim 28, wherein the wireless interrogator circuit is further configured to receive one of the transponder signals of the first polarization type or the transponder signals of the second polarization type and to decode the information encoded as the sequence based at least in part on an interruption in the received transponder signals of the first polarization type or in the received transponder signals of the second polarization type.

30. A method of wireless communication comprising:
receiving interrogation signals at a wireless transponder;
determining information for transmission from the wireless transponder; and
sending the information from the wireless transponder encoded in a sequence of transponder signals of a first polarization type alternating with transponder signals of a second polarization type different than the first polarization type.

31. The method of claim 30, wherein the transponder signals of the first polarization type comprise linearly polarized transponder signals having a first orientation, and the transponder signals of the second polarization type comprise linearly polarized transponder signals having a second orientation different than the first orientation.

32. The method of claim 30, wherein the transponder signals of the first polarization type comprise left hand elliptically polarized transponder signals, and the transponder signals of the second polarization type comprise right hand elliptically polarized transponder signals.

33. The method of claim 32, wherein the left hand elliptically polarized transponder signals comprise left hand circularly polarized transponder signals, and the right hand elliptically polarized transponder signals comprise right hand circularly polarized transponder signals.

34. The method of claim 30, wherein sending the information includes switching between a first antenna configured to send the transponder signals of the first polarization type and a second antenna configured to send the transponder signals of the second polarization type.

35. The method of claim 30, wherein sending the information includes reconfiguring a reconfigurable antenna between a first configuration for sending the transponder signals of the first polarization type and a second configuration for sending the transponder signals of the second polarization type.

36. The method of claim 30, wherein receiving the interrogation signals comprises receiving interrogation signals of the first polarization type while sending the transponder signals of the first polarization type and receiving interrogation signals of the second polarization type while sending the transponder signals of the second polarization type.

37. The method of claim 30, wherein sending the information includes backscattering the interrogation signals.

38. The method of claim 30, wherein receiving the interrogation signals includes collecting power from the interrogation signals.

39. A method of wireless communication comprising:
transmitting interrogation signals from a wireless interrogator;
receiving a sequence of transponder signals of different polarization types at the wireless interrogator; and
decoding information encoded in the sequence of transponder signals of different polarization types.

40. The method of claim 39, wherein the sequence of transponder signals of different polarization types comprise linearly polarized transponder signals having a first orientation alternating with linearly polarized transponder signals having a second orientation different than the first orientation.

41. The method of claim 39, wherein the sequence of transponder signals of different polarization types comprise left hand elliptically polarized transponder signals alternating with right hand elliptically polarized transponder signals.

42. The method of claim 41, wherein the left hand elliptically polarized transponder signals comprise left hand circularly polarized transponder signals, and the right hand elliptically polarized transponder signals comprise right hand circularly polarized transponder signals.

43. The method of claim 39, wherein transmitting the interrogation signals includes transmitting interrogation signals of a first polarization type and interrogation signals of a second polarization type different than the first polarization type substantially simultaneously.

44. The method of claim 39, wherein receiving the sequence of transponder signals of different polarization types includes receiving transponder signals of a first polarization type and transponder signals of a second polarization type different than the first polarization type via separate interrogator antennas.

45. The method of claim 39, wherein receiving the sequence of transponder signals of different polarization types includes receiving one of transponder signals of a first polarization type or transponder signals of a second polarization type different than the first polarization type, and decoding the information encoded in the sequence includes interpolating the sequence based at least in part on an interruption in the received transponder signals of the first polarization type or in the received transponder signals of the second polarization type.

46. The method of claim 39, wherein transmitting the interrogation signals includes transmitting interrogation information in an interrogation sequence of interrogation signals of a first polarization type alternating with interrogation signals of a second polarization type different than the first polarization type.
